(19) United States
(12) Patent Application Publication
(10) Pub. No.: US 2017/0052519 A1
(43) Pub. Date: Feb. 23, 2017

(54) FORMING A LOGICAL MICROCONTROLLER FROM AT LEAST TWO PHYSICAL MICROCONTROLLERS ON A COMMON SEMICONDUCTOR SUBSTRATE

(71) Applicant: Robert Bosch GmbH, Stuttgart (DE)

(72) Inventors: Axel Aue, Korntal-Muenchingen (DE); Hans-Walter Schmitt, Weissach/Flacht (DE)

(21) Appl. No.: 15/306,937

(22) PCT Filed: Feb. 24, 2015
(86) PCT No.: PCT/EP2015/053786

§ 371 Date: Oct. 26, 2016

(30) Foreign Application Priority Data
Apr. 30, 2014 (DE) 10 2014 208 177.7

(51) Int. Cl. G05B 19/042; G06F 13/42; G06F 13/40

(52) U.S. Cl. CPC G05B 19/0421; G06F 13/4068; G06F 13/4282; G06F 13/4204; G05B 2219/2224; G05B 2219/45018

(57) ABSTRACT

A system of at least two microcontrollers on a common semiconductor substrate, each of the at least two microcontrollers respectively having one hardware interface, and the at least two microcontrollers being coupled in data-transmitting fashion via the hardware interfaces by a coupling device.

### FIELD

The present invention relates to a system of at least two microcontrollers on a common semiconductor substrate, internal structures of the microcontrollers being coupled in data-transmitting fashion, in particular for the joint usage of the respective resources, as well as to a method for producing such a system.

### BACKGROUND INFORMATION

In control units, for example for controlling machines, facilities, motor vehicles and commercial vehicles, or in consumer electronics, e.g., in mobile telephones or television sets, the individual components of the control unit communicate with one another. The task of an engine control unit of an internal combustion engine for example is to calculate output variables for actuators (such as fuel injector or ignition system) from a plurality of input signals (such as e.g.

rotational speed, temperature or pressure). For this purpose, a control unit has integrated circuits (ICs) as components, such as microcontrollers, ASICs, ASSPs, etc.

Microcontrollers are small complete computer systems having inter alia their own processor and memory, which are developed as a single integrated circuit. ASIC is the acronym for application-specific integrated circuit. ASSP is the acronym for application-specific standard product.

Due to the complex functions that a microcontroller is able to perform, a microcontroller is often a central component of a control unit and controls all other components of the control unit, in particular other ICs. The microcontroller usually also stores the data, characteristics maps and/or programs necessary for operation, also for other components that have no memory or too little memory of their own.

For various applications, for example the above-mentioned control of an internal combustion engine, usually special microcontrollers are specified and designed, which cover a specific application segment. Because of the great design effort and thus high design and production costs, however, it is often economically not practical to manufacture or offer microcontrollers that are designed for specific applications, yet are required only in small quantities.

It is therefore desirable to indicate an option for providing microcontrollers specifically for applications that also require little design effort.

### SUMMARY

The present invention provides for a system of at least two microcontrollers on a common semiconductor substrate and a method for their production. Advantageous developments are described herein.

A system according to the present invention has at least two microcontrollers, in particular automotive microcontrollers, which are situated on a common semiconductor substrate, each of the at least two microcontrollers having at least one hardware interface, and the at least two microcontrollers being coupled in data-transmitting fashion by a coupling device via the hardware interfaces. The system thus represents outwardly in particular one logical microcontroller, which is internally composed of the at least two (physical) microcontrollers.

In particular, each of the at least two microcontrollers is also functional on its own. Thus, it is possible to combine a specific number of microcontrollers such that it is possible to use the resources of all microcontrollers jointly. Thus, it is also possible to use, depending on the requirement, the necessary number of microcontrollers, only a small design effort being required for this purpose, namely, for the design of the system on the semiconductor substrate and of the coupling device. In particular, it is advantageous that already existing designs of microcontroller may be used, which only need to be supplemented with the hardware interface. These microcontrollers may then continue to be used in a “stand alone” manner, but may also be combined into larger logical microcontrollers. It is therefore possible to produce even small quantities efficiently and a costly design of specific microcontrollers is no longer necessary. In addition, two microcontrollers are able to fulfill more functionalities.

For example, a microcontroller may thus be used by itself in a control unit for an internal combustion engine having four cylinders, and a system, according to the present invention, of two such microcontrollers may be used for a control unit for an internal combustion engine having eight cylinders.

The at least two microcontrollers preferably each have the same range of functions. Thus, it is possible to provide in a cost-effective manner systems having different functional ranges using only one type of microcontroller.

Alternatively, one microcontroller has a range of functions that is different from that of another microcontroller. Using two types of microcontrollers, it is thus possible, for example, to provide systems having many different ranges of functions.

Due to the small structure widths of modern technologies, it is possible for the hardware interfaces to be developed advantageously as parallel interfaces. For coupling, it is possible to use buses (AHB, LMB, . . . ) having x bit width (x in particular 1 . . . 512), in particular conventional so-called on-chip buses. Due to the parallelism of the transmission, the data rate is substantially higher, and a performance is achieved that is comparable to a situation where the resources are implemented on the same chip. For this purpose, the coupling device may be developed as multiple circuit traces on the semiconductor substrate.

Another advantageous form of implementation is to develop the respective hardware interfaces as serial interfaces and to couple the at least two microcontrollers via a serial connection. For this purpose, the coupling device may be developed as single circuit traces on the semiconductor substrate. As a result, no large structures are required for protection against electrostatic discharges or driver structures in the microcontrollers, which would limit the speed of the microcontrollers. RS-232 is suitable as a simple serial connection. According to a preferred development, the serial connection may also be developed as a serial bus. Suitable buses are in particular I2C, SPI, LIN or CAN.

The use of a system according to the present invention is particularly advantageous in a processing unit that is designed in particular for controlling an internal combustion engine since internal combustion engines are often produced in many different specific embodiments, often only in small quantities. A system according to the present invention, however, may also be used in processing units for controlling other functions, both in the automotive sector as well as in other areas.

In a method according to the present invention for producing the system of the present invention of at least two microcontrollers on the common semiconductor substrate, the at least two microcontrollers are developed in a region of the semiconductor substrate, in particular side by side. The system of the at least two microcontrollers on the common semiconductor substrate is produced in such a way as if it were a single microcontroller, i.e., in such a way that the production steps essentially occur in parallel. If a lithography method is used as the production method, the at least two microcontrollers are processed in parallel in each exposure step, development step and processing step (e.g., etching, application of metal, etc.)

If reticles are used as masks in the exposure, the exposure step may also occur separately for each microcontroller in that first one microcontroller is exposed through a reticle and subsequently another. Alternatively it is also possible to expose multiple microcontrollers simultaneously through multiple reticles arranged side by side or through a common reticle that bears the structures of multiple microcontrollers. Proven designs may be combined on reticles so that one reticle is provided for each desired range of functions, on which masks for multiple microcontrollers are situated. Alternatively, it is also possible to provide a design having one microcontroller per reticle.

Additional advantages and developments of the present invention derive from the description herein and the figures.

It is understood that the features mentioned above and the features yet to be explained below may be used not only in the combination indicated in each case but also in other combinations or in isolation, without departing from the scope of the present invention.

The present invention is represented schematically in the figures in the light of an exemplary embodiment, and is described in detail below with reference to the figures.

### BRIEF DESCRIPTION OF THE DRAWINGS

FIG. 1 shows schematically a system according to the present invention of two microcontrollers on a semiconductor substrate in a preferred development.

### DETAILED DESCRIPTION OF EXAMPLE EMBODIMENTS

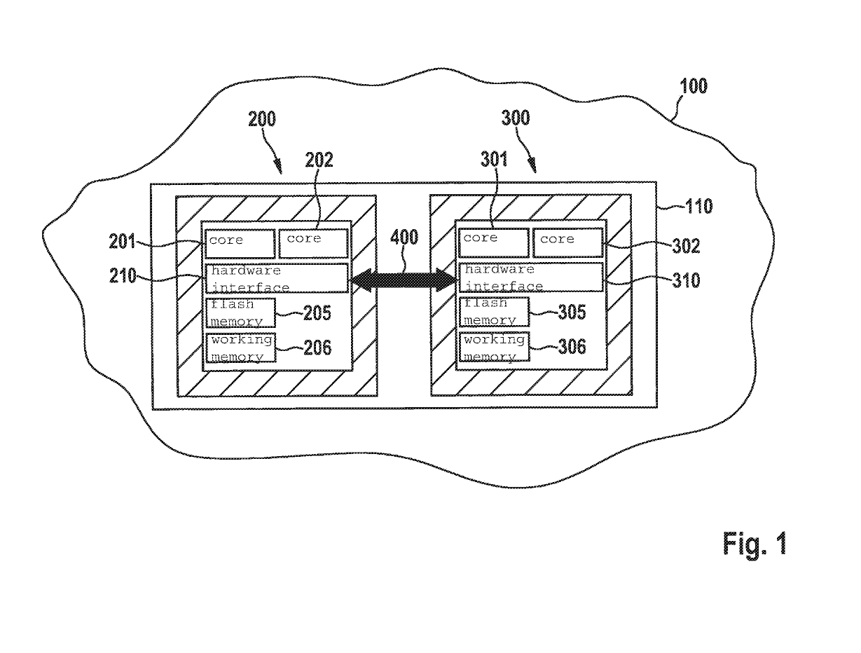

FIG. 1 schematically shows a semiconductor substrate 100 developed as a silicon wafer, on which two microcontrollers 200, 300 are mounted or situated. By way of example, both microcontrollers 200, 300 are developed identically, but both microcontrollers may also have different ranges of function.

By way of example, microcontroller 200 includes two processor cores 201, 202, a flash memory 205 and a working memory 206. Microcontroller 200 furthermore includes a hardware interface 210, via which it is possible to establish a connection from outside, in particular to the processor cores 201, 202.

Microcontroller 300 also includes two processor cores 301, 302, a flash memory 305, a working memory 306 and a hardware interface 310. Hardware interfaces 210, 310 are here developed as AHB interfaces (advanced high-performance bus).

Both microcontrollers 200, 300 are situated side by side on semiconductor substrate 100 and forma system 110, which was produced like a single microcontroller and which also behaves as such outwardly.

Microcontrollers 200, 300 are connected by a coupling device 400 via hardware interfaces 210, 310 of microcontrollers 200, 300. In an AHB bus, coupling device 400 are developed as x circuit traces (x dependent on the internal bus width of the architecture and the performance segment of the pC), which are mounted on the semiconductor substrate. This is particularly easy to produce.

The microcontrollers 200, 300 are preferably existing (and thus already proven and optimized) designs, which merely had to be extended by the coupling option (i.e., in particular by the hardware interface and possibly coupling device). In particular, they also continue to be functional in single operation, but may now, however, also be coupled to form larger systems according to the present invention. This allows for savings in the design work of more than 90% compared to the design of a new microcontroller having a comparable range of functions.

The system according to the present invention is not limited to two microcontrollers, as even three or more microcontrollers may be suitably situated on semiconductor substrate 100 and be coupled via the hardware interfaces.

1-10. (canceled)

11. A system, comprising:
at least two microcontrollers on a common semiconductor substrate, each of the at least two microcontrollers having respectively one hardware interface, and the at least two microcontrollers being coupled in data-transmitting fashion via the respective hardware interfaces by a coupling device.

12. The system as recited in claim 11, wherein the at least two microcontrollers each have the same range of functions.

13. The system as recited in claim 11, wherein one microcontroller of the at least two microcontrollers have a range of functions that is different from that of another microcontroller of the at least two microcontrollers.

14. The system as recited in claim 11, wherein the hardware interfaces being developed as bus interfaces.

15. The system as recited in claim 11, wherein the hardware interfaces are developed as parallel or serial interfaces.

16. The system as recited in claim 11, wherein the coupling device have one or multiple circuit traces.

17. The system as recited in claim 11, wherein the at least two microcontrollers are produced like a single microcontroller.

18. The system as recited in claim 11, wherein the system is designed in such a way that outwardly it behaves like a single microcontroller.

19. A processing unit, comprising:
a system including at least two microcontrollers on a common semiconductor substrate, each of the at least two microcontrollers having respectively one hardware interface, and the at least two microcontrollers being coupled in data-transmitting fashion via the respective hardware interfaces by a coupling device;
wherein the processing unit being designed to control an internal combustion engine.

20. A method of producing a system, the method comprising:
producing at least two microcontrollers on a common semiconductor substrate, each of the at least two microcontrollers having respectively one hardware interface, and the at least two microcontrollers being coupled in data-transmitting fashion via the respective hardware interfaces by a coupling device, the at least two microcontroller being produced like a single microcontroller.
